(19) United States
(12) Patent Application Publication
(10) Pub. No.: US 2012/0321803 A1
(43) Pub. Date: Dec. 20, 2012

(54) COMPOSITIONS OF METAL OXIDES FUNCTIONALISED BY OLIGOMER SILOXANOLS AND USE THEREOF

(75) Inventors: Bjoern Borup, Frankfurt (DE); Mike Achtzehn, Lindau (DE); Burkhard Standke, Loerrach (DE); Christian Wassmer, Hausen (DE)

(73) Assignee: Evonik Degussa GmbH, Essen (DE)

(21) Appl. No.: 13/580,194

(22) PCT Filed: Dec. 27, 2010
(86) PCT No.: PCT/EP2010/070745

§ 371 Date: Aug. 21, 2012

(30) Foreign Application Priority Data
Feb. 25, 2010 (DE) 102010002356.6

(51) Int. Cl. C07F 7/02; B32B 5/16; B05D 7/14

(52) U.S. Cl. 427/327; 556/9; 556/400; 428/402

(57) ABSTRACT

The invention relates to a method for producing aqueous, essentially solvent-free compositions based on pyrogenous metal oxides functionalised by oligomer siloxanols, to the corresponding compositions, and to the use thereof for corrosion protection and adherence.

The invention relates to a process for preparing aqueous, substantially solvent-free compositions based on fumed metal oxides functionalized with oligomeric siloxanols, and also to the corresponding compositions, and to the use thereof for corrosion protection and for promotion of adhesion.

Dispersions based on the reaction of a glycidyloxypropylalkoxysilane with an aqueous silica sol are known from EP 1 773 958 A1 and US 2008/0058489. These systems are used as inorganic binders in the production of casting molds. DE 198 14 605 A1 discloses a composition comprising glycidyloxysilane and, for example, lithium polysilicate. EP 1 288 245 A2 discloses compositions from the reaction of an aqueous silica sol with alkyltrialkoxysilanes and an alkoxysilane.

A disadvantage of the composition of DE 198 14 605 A1 is the lack of chemical attachment of the silane to the surface of the particles in the silica sol used, i.e., lack of formation of covalent bonds. There is no durable crosslinking of the particles with the silane, of a kind resistant to relatively severe stress, owing to the adhesion which is formed, this adhesion being based only on Van der Waal's forces and/or hydrogen bonds. Permanent corrosion protection is therefore not offered by the seals produced from these compositions. Chemical attachment of the silanes to the inorganic particles enhances the chemical fixing of the metal oxide particles on an applied substrate, as for example a metallic substrate.

The stated publications disclose silica sols containing an existing colloidal silicon dioxide which is obtained from sodium silicate. At acidic or basic pH levels, the aqueous dispersions are stable and have particle sizes of 20 to 100 nm. As an inevitable result of the preparation process, the silica particles are round particles and have a series of impurities, such as extraneous metals and chlorides, sulfates or other anionic constituents. As an inevitable result of the production process, these extraneous metals contaminate the silica sols and can lead to problems in the subsequent application.

As a result of the much lower production-related impurities in fumed silica, its use in coating systems is preferred. From the prior art, silane- or siloxane-modified, purely aqueous metal coating materials of fumed silicas are unknown. This may be because the stabilizing of aqueous dispersions of fumed silicas is difficult to achieve, by adjusting the dispersions to high pH levels or by stabilizing them with aluminum compounds. The high pH level or the addition of aluminum compounds is also desirable in numerous applications.

One object was to provide stable, purely aqueous compositions based on fumed metal oxides functionalized with oligomeric siloxanes. These compositions are to exhibit improved performance properties, more particularly in use and/or after curing, relative to the known systems identified above. A particular focus, therefore, was the provision of a process for preparing these compositions with chemically functionalized fumed metal oxides, such as with fumed silica or with fumed silicas modified metal oxides. Chemical functionalization is understood to be the formation of covalent bonds between the oligomeric siloxanol and the fumed metal oxide.

The objects are achieved in accordance with the details in the independent or co-independent claims. Preferred embodiments are recorded in the dependent claims and in detail in the description.

Surprisingly it has been found that a purely aqueous composition, i.e., one substantially free from organic solvents or organic polymers, comprising a fumed metal oxide functionalized with oligomeric siloxanols, is obtainable by the process of the invention and is especially stable. Thus the compositions of the invention are stable at room temperature for at least one month, preferably for at least three months, more preferably 12 months, very preferably 24 months, under these conditions.

A composition is adjudged to be stable if over a broad pH range it is liquid or is liquid again after having been agitated, more particularly at pH levels of below 9 as well. All in all, the compositions of the invention are surprisingly stable at low pH levels between 1 and 7. The compositions preferably have a pH of between 2 to 6, more preferably between 3 and 5. Equally, however, it is also possible to provide stable compositions at high pH levels, such as, preferably, between pH 7 to 12, more preferably between 8 to 11.

The object has been achieved, surprisingly, by a process for preparing a composition comprising fumed metal oxides functionalized with oligomeric siloxanols, by intensively mixing, in a purely aqueous phase, an organofunctional, substantially completely hydrolyzed siloxanol (i) with at least one fumed metal oxide (ii).

The invention accordingly provides a process for preparing a composition comprising fumed metal oxides functionalized with oligomeric siloxanols, and compositions obtainable by this process, by intensively mixing
(i) at least one aqueous, substantially completely hydrolyzed, oligomeric, and organofunctional siloxanol or a mixture of substantially completely hydrolyzed, oligomeric, and organofunctional siloxanols which is substantially free from organic solvents, more particularly substantially free from alcohols, and free from polymers based on organic hydrocarbons, and
   in which each silicon atom of the siloxanol has at least one functional group, and the functional group is identical or different, more particularly is an organofunctional group R in a structural element, and is selected
   a) to an extent of 50% to 100%, more particularly 80% to 100%, more preferably 90% to 100% from organofunctional groups aminoalkyl, N-alkylaminoalkyl, diaminoalkyl, triaminoalkyl, bis-N-aminoalkyl, bis-N-aminoalkylsilyl, tris-N-aminoalkyl, tris-N-aminoalkylsilyl, mercaptoalkyl, methacryloyl, methacryloyloxyalkyl, hydroxyalkyl, epoxyalkyl, glycidyloxyalkyl, hydrolyzed glycidyloxyalkyl, polysulfane, disulfane, thioether, polyether, vinyl, alkyl, more particularly having 1 to 50 C atoms, alkenyl, more particularly having 1 to 8 C atoms, alkynyl, aryl, alkylaryl, haloalkyl, ureido, sulfanealkyl, cyanate and/or isocyanate groups or else optionally quarternary-aminoalkyl, the organofunctional groups being linear, branched and/or cyclic, and
   b) to an extent of 0% to 50%, more particularly 0% to 20, more preferably 0% to 10% of the hydroxyl group,
   and the remaining free valences of the silicon atoms in the oligomeric siloxanols are satisfied by hydroxyl groups; more particularly the groups according to a) and b) make 100% in total,
      with
(ii) at least one fumed metal oxide selected from the group of silica, metal oxide modified silica, and a metal oxide comprising at least
   one metal or semimetal from main groups two to six and/or transition groups one to eight of the Periodic Table of the Elements, particular preference being given to metal oxides comprising silicon, aluminum, zirconium, titanium, iron, cerium, indium, samarium, tin, zinc, antimony, arsenic, tantalum, rhodium, ruthenium, cobalt, nickel, copper, silver, germanium, and/or corresponding mixed oxides or metal oxides modified therewith, more particularly being dispersed and/or reacted, i.e., the purely aqueous, oligomeric siloxanol reacts with a fumed metal oxide, with the formation of covalent bonds,
   optionally in the presence of a hydrolysis and/or condensation catalyst, such as an acid, base or metal salt, more particularly metal fluorides or organometallic compounds, such as a metal alkoxide, for example.

The oligomeric siloxanols which are used, which more particularly are purely aqueous, may further comprise esters of metal acids, and also hydrolyzed esters of metal acids, and also metal salts. Examples of such metal acid esters are alkyl titanates such as butyl titanate, propyl titanate, isopropyl titanate or corresponding zirconates.

With particular preference the oligomeric siloxanols which are used in the process, and which more particularly are substantially purely aqueous, have on average a degree of oligomerization of at least 4; more preferably they have a degree of oligomerization on average of 4 to 100 000, more preferably 4 to 50 000. The molecular weight determination can be determined via field-flow fractionation. The siloxanols used are based, in accordance with the invention, on hydrolyzates and/or homo-, co-, block-co-condensates or mixtures of the alkoxysilanes substituted with the abovementioned organofunctional groups, and/or of tetraalkoxysilanes. Only to a negligible extent is it possible for remaining free valences of the silicon atom in the oligomeric siloxanols to be satisfied by hydroxyl groups and, in a very small fraction, with alkoxy groups.

The utilization of pyrogenically prepared silicas or pyrogenically prepared metal oxides encompasses, in accordance with the invention, metal oxides and/or silicas which are capable of reacting with the oligomeric, hydroxy-functionalized silanes to form covalent bonds; more particularly, the metal oxides possess hydroxyl groups. Preferred metal oxides are selected from the oxides of the metals silicon, aluminum, zirconium, titanium, tin, cerium, and indium, and also mixed oxides of the stated metals as well. Furthermore, preference is given to fumed silicas or mixed oxides with silicon dioxide, and also fumed silicas which during the actual production procedure are doped with metal oxides (as described, for example, in patent EP 1216956 or EP 850876).

Particularly preferred fumed metal oxides are SiO₂, Al₂O₃, TiO₂, HfO₂, Y₂O₃, ZrO₂, Fe₂O₃, Nb₂O₅, V₂O₅, WO₃, SnO₂, GeO₂, B₂O₃, In₂O₃, ZnO, CaO, manganese oxides, lead oxides, MgO, BaO, SrO and/or corresponding mixed oxides, or metal oxides modified therewith. Furthermore, it is also possible for fumed metal oxides, of the kind known, for example, from the documents below, to be used in the process of the invention. The disclosure content of the following documents is referenced in full, their content hereby being adopted into this specification: U.S. Pat. No. 7,241,336, which discloses a mixed oxide containing aluminum and silicon, EP 1 284 277, which discloses SiO2-coated oxides, EP 1 216 956, EP 1 236 773, U.S. Pat. No. 6,627,173, EP 1 083 146, EP 1 048 617, EP 0 995 718 and also EP 0 850 876, and EP 0 585 544.

It has emerged, surprisingly, that the use of fumed silica has a distinct advantage over the aqueous silica sols for morphological reasons as well. The reasons for this lie in the morphology of the fumed silicas or fumed metal oxides, since they have a fractal structure or fractal morphology, which forms from the very small, generally 2 to 100 nm, but also 5 to 10 nm-sized, primary particles during pyrogenesis, more particularly by agglomeration or coalescence of the primary particles to form larger particles or a larger assembly.

By virtue of this irregular particle geometry/morphology, the coatings that are obtained from the compositions and/or functionalized fumed metal oxides of the invention have the advantage, relative to the round particles in the silica sols, that the next layer exhibits a significantly improved adhesion on the coating than on the known coatings. As a result of this improved adhesion, the propensity toward subfilm migration is lessened, and hence enhanced corrosion protection is obtained. Furthermore, the compositions that are prepared of functionalized fumed metal oxides, more particularly of the fumed silica or metal-oxide-modified silicas, contain the aggressive chlorides only at a level in the region <0.5% by weight down into the ppb region, as for example down to 1 ppb, preferably <0.5% by weight, more preferably <0.3% by weight, very preferably <0.1% by weight, and so from this aspect as well the use of fumed metal oxides leads to improved corrosion protection coatings.

Fumed metal oxides, more particularly silicas or metal-oxide-modified silica, used with preference in the process have primary particles having an average particle diameter of less than 1 μm, more particularly of about 50 to 400 nm, more preferably of 90 to 200 nm (median figure, determination by static light scattering). With very particular preference it is possible in the process of the invention to use particularly small primary particles, more particularly in the form of agglomerates, in which the primary particles of the fumed metal oxide have an average particle size (d₅₀) of between 2 to 100 nm, more particularly between 10 to 70 nm, preferably between 10 to 60 nm.

The process of the invention can be carried out purely aqueously, more particularly substantially without presence of organic solvents, such as alcohols, resins or of prepolymers of resins, such as synthetic resin or prepolymers, such as acrylate, methacrylate, epoxide, polyurethane, unsaturated polyester. Considered as alcohols and organic solvents are the typical alcohols, more particularly the hydrolysis alcohols, glycols, ethers, esters, ketones, aldehydes, such as, more particularly, ethanol, methanol, propanols (n-, iso-), butanols (isomeric butanols), 1-methoxy-2-propanol, 1-methoxypropanol, amyl alcohol, polyethers, polyols, acrylates, resins, PU acrylates, styrene acrylate, polyvinyl alcohols, aqueous epoxy resin dispersions, and also all other solvents known to the skilled person. Furthermore, the oligomeric siloxanols used in the process, and/or the oligomeric silanes from which the siloxanols are derived, are substantially completely hydrolyzed, and so during their reaction as well it is no longer possible for substantially any hydrolysis alcohol to be released.

An oligomeric siloxanol or else an oligomeric silane is considered to be substantially completely hydrolyzed when it is substantially no longer able to give off any hydrolysable alkoxy groups, i.e., no alcohol is given off any longer, substantially, during crosslinking as well. With particular preference it may be free from hydrolysable methoxy, ethoxy, propoxy and/or butoxy groups which form volatile alcohols. The amount of alkoxy groups in the oligomeric siloxanols, more particularly those utilized for preparing the composition, is preferably less than 10% to 0% by weight, more particularly less than 5% to 0% by weight, preferably less than 3% to 0% by weight, more preferably less than 2% to 0% by weight, and even more preferably less than or equal to 1% to 0% by weight, better still 0.5% to 0% by weight or else 0.1% to 0% by weight, based on the dry weight of the oligomeric siloxanols. An aqueous oligomeric siloxanol is regarded as substantially free from organic alcohols, more particularly from solvents, when its alcohol content, more particularly its solvent content, is less than 5% to 0.0001% by weight in relation to the overall composition of the aqueous oligomeric siloxanol, more particularly down to the detection limit. The amount in the overall composition is preferably less than 3% by weight to 0.0001% by weight, better still down to the detection limit, more preferably less than 1% by weight, more preferably less than 0.5% by weight, with 0.1% by weight being used with particular preference.

The organofunctional, oligomeric siloxanol used in the process may also have already been modified with a silica sol. An organofunctional group R, which may independently of one another be identical or different, is understood preferably to include an organofunctional group R on one of the structural elements below. For better understanding, the aqueous, oligomeric siloxanol used may also be formed from structural elements joined covalently via siloxane bridges (Si—O—Si), more particularly with the structural groups M, D, T or Q. In accordance with the invention the aqueous oligomeric siloxanol possesses at least two of the following structural elements, selected from: —O—Si(OH)(R)—; —O—Si(OH)₂(R), (—O—)₂(HO)SiR, (—O—)₃SiR, (—O—)₂Si(OH)₂, (—O—)₃Si(OH), —O—Si(OH)₂—; —O—Si(R)₂—; —O—Si(OH)(R)₂ and/or (—O—)₂Si(R)₂, preferably at least —O—Si(OH)(R)—; —O—Si(OH)₂(R), and/or (—O—)₂(HO)SiR, i.e., also via at least one siloxane linkage Si—O—Si; —, and optionally also three-dimensionally crosslinked Si—R having up to three siloxane Si—O—Si bonds, where R corresponds to an organofunctional group with the stated definition; preferably, the oligomeric siloxanols have at least four structural elements, i.e., they have at least a degree of oligomerization of 4, containing more preferably on average 4 to 100 000 of the structural elements, more preferably 4 to 50 000 structural elements. The molecular weight determination may be determined via field-flow fractionation.

It is preferred for all of the silicon atoms to be substituted at least once and/or twice by organofunctional groups, more particularly by the group R, with the remaining free valences of the silicon atoms being satisfied by hydroxyl groups or by a siloxane linkage. In traces there may also be alkoxy groups present. Alternatively it is possible for silicon atoms to be substituted once or twice by organofunctional groups R, and for other silicon atoms to carry only hydroxyl groups or siloxane linkages, as for example (—O—)₄Si and/or (—O—)₂Si(OH)₂. Examples thereof are oligomers from the reaction of fluoroalkyltriethoxysilane and tetraethoxysilane. The oligomeric silanes described preferably have at least four silicon atoms joined via siloxane bridges.

It has been found particularly advantageous to add the fumed metal oxide in the form of metal oxide powder to the aqueous, oligomeric siloxanols with simultaneous, high input of energy, more particularly by dispersing the fumed metal oxide with the oligomeric silane using high stirring and/or mixing speeds. In accordance with the invention the fumed metal oxide is added in the form of metal oxide powder to the aqueous, oligomeric siloxanols and is dispersed with high input of energy with the oligomeric siloxanols, by means of high stirring and/or mixing speeds. The process therefore encompasses the following steps (i) consisting of a) initial introduction of the aqueous, oligomeric siloxanes, b) addition of the fumed metal oxides, and c) mixing, optionally in the presence of an auxiliary agent, hydrolysis and/or condensation catalysts; more particularly, steps b) and c) are carried out substantially simultaneously, iteratively or directly one after another, optionally in alternation; and optionally at least one step (ii), in which the addition of further components such as customary auxiliaries is possible, such as, for example—but not exclusively—wetting assistants, bases, acids, emulsifiers, coatings raw materials, water, solvents, compositions comprising these, and other formulating adjuvants known to the skilled person for the production, for example, of metal pretreatment compositions, paints, inks, bonding-agent compositions or other formulations for numerous applications. In accordance with the invention the dispersing takes place at stirring speeds of up to 1000 revolutions per minute. Optionally an auxiliary may be present. The mixing and/or the reaction take place, with particular preference, with high shearing forces being supplied. The mixing and/or dispersing, more particularly the reaction as well, take place preferably at 1000 to 10 000 revolutions/minute, more preferably at 1500 to 9500 revolutions/minute, with particular preference at 1500 to 8500 revolutions/minute. In accordance with the invention the reaction can take place in stages, more particularly in two stages, in which case first of all dispersing and/or mixing is carried out at 1000 to 3000 revolutions/minute, and subsequently dispersing and/or mixing are carried out at 6000 to 9000 revolutions/minute. Examples of suitable mixing assemblies are as follows: Ultraturrax (rotor stator disperser), dissolver, bead mills, wet-jet mill, single-stage and multistage homogenizers. Dispersion in stages may take place for between 1 minute to 10 hours per stage, preferably 2 to 60 minutes, more preferably 2 to 15 minutes, better still between 5 to 20 minutes.

As a result of the process of the invention it is possible to disperse the fumed metal oxide at surprisingly high concentration into a substantially aqueous and substantially solvent-free phase containing oligomeric siloxanols. Prior to the addition of the fumed metal oxide, the phase consists preferably of oligomeric siloxanes, water, and optionally hydrolysis and/or condensation catalysts, and a solvent content of below 0.5% by weight down to the detection limit. Preferably, therefore, it is possible to disperse between 0.001% to 60% by weight of fumed metal oxide in relation to the overall composition, more particularly 0.01% to 20% by weight. The amounts are based preferably on a purely aqueous, substantially solvent-free composition comprising fumed metal oxides functionalized with oligomeric silanes.

In the process of the invention it is preferred to set a viscosity of between 5 to 8000 m·Pas, more particularly between 10 to 4000 m·Pas, preferably between 15 to 1500 m·Pas or more preferably between 20 to 500 m·Pas. The same applies for the composition. The viscosity is determined in general by a method based on DIN 53015.

The compositions of the invention are notable advantageously for a low viscosity in conjunction with high solids content, as demonstrated by the working examples and figures. This combination of low viscosity and high solids content is a necessary precondition for high capacity in the production of coatings.

Also provided in accordance with the invention is a process for preparing a composition comprising functionalized fumed metal oxides, and also a composition obtainable by the process of the invention, by preparing and/or initially introducing, more particularly in a first step,
a) aqueous, substantially solvent-free, more particularly alcohol-free, and substantially completely hydrolyzed oligomeric, organofunctional siloxanols,
   in which the siloxanols are preferably in solution in the aqueous phase, more preferably in complete solution in the aqueous phase, and more particularly contain reactive hydroxyl groups; and
   the oligomeric siloxanols have at least two of the following structural elements selected from —O—Si(OH)(R)—; —O—Si(OH)₂(R), (—O—)₂(HO)SiR, (—O—)₃SiR, (—O—)₂Si(OH)₂, (—O—)₃Si(OH), —O—Si(OH)₂—; —O—Si(R)₂—; —O—Si(OH)(R)₂ and/or (—O—)₂Si(R)₂, preferably at least —O—Si(OH)(R)—; —O—Si(OH)₂(R), and/or (—O—)₂(HO)SiR; more particularly at least one structural element, preferably 4 to 100 000 of the structural elements, has at least one reactive hydroxyl group, and in which R in the structural elements is identical or different and R is an organofunctional group selected from amino, aminoalkyl, more particularly N-alkylaminoalkyl, diaminoalkyl, triaminoalkyl, bis-N-aminoalkyl, bis-N-aminoalkylsilyl group, tris-N-aminoalkyl, tris-N-aminoalkylsilyl group, quaternary-aminoalkyl, mercaptoalkyl, methacryloyl, methacryloyloxyalkyl, hydroxyalkyl, more particularly a vicinal dihydroxyalkyl; epoxyalkyl, glycidyloxyalkyl, hydrolyzed glycidyloxyalkyl, polysulfane, disulfane, thioether, polyether, vinyl, alkyl, alkenyl, alkynyl, aryl, alkylaryl, haloalkyl, more particularly fluoroalkyl, chloroalkyl, bromoalkyl; ureido, sulfanealkyl, cyanate and/or isocyanate groups, the organofunctional groups being linear, branched and/or cyclic,
   and siloxanols have on average at least 4 structural elements, containing preferably on average 4 to 100 000 of the structural units, more preferably on average 4 to 50 000,
   optionally in the presence of hydrolysis and/or condensation catalysts, and more particularly in a further step, carrying out mixing and reaction with
b) at least one fumed metal oxide, which more particularly has functionalities that are reactive toward hydrolyzed oligomeric siloxanol, preferably with fumed silica, with a metal-oxide-modified silica, as has been described above.

With regard to the preparation of the oligomeric siloxanols, reference is made completely to the disclosure content of the patent specifications identified below, the content of which is hereby adopted into this specification.

The catalyst optionally present may be, for example, an acid, and may in general originate from the preceding, substantially complete hydrolysis and partial condensation of alkoxysilanes, more particularly of monomeric, oligomeric and/or polymeric alkoxysilanes, or else from the preparation of substantially completely hydrolyzed homocondensates and/or block cocondensates. The catalyst may typically be formic acid, acetic acid or nitric acid, although other acids familiar to the skilled person are contemplated here. As catalyst it is possible additionally or alternatively to use other typical catalysts as well that promote hydrolysis and/or condensation of the siloxanols. These catalysts also are familiar to the competent skilled person. They may, for example, be the aforementioned catalysts. In the process of the invention it is possible with preference to do without the addition of crosslinkers, such as n-propyl zirconate, butyl titanate, and titanium acetylacetonate. This is possible because compounds that are already oligomeric are used. It is preferred, further, if the compositions comprising the functionalized metal oxide are substantially free of these crosslinkers, especially if glycidyloxypropylalkoxysilanes are used, optionally together with fluoroalkyl-functional, water-soluble silicon compounds.

As auxiliaries in the process or in the composition it is possible more particularly to use a dispersion assistant, rheological assistant, wetting agent, e.g., surfactants. With preference it is possible to do without the use of one of these auxiliaries in the process or else in the composition of the invention.

Oligomeric siloxanols which in accordance with the present invention are used in the process are siloxanols, more particularly those having at least two of the stated structural elements, or else polysiloxanols with these structural elements, which possess a reactive hydroxyl group on at least one silicon atom, and possess organofunctional groups, more particularly as R in the structural elements; in particular, the functional group is identical or different and is selected from aminoalkyl, N-alkylaminoalkyl, diaminoalkyl, triaminoalkyl, bis-N-aminoalkyl, bis-N-aminoalkylsilyl, tris-N-aminoalkyl, tris-N-aminoalkylsilyl, mercaptoalkyl, methacryloyl, methacryloyloxyalkyl, hydroxyalkyl, epoxyalkyl, glycidyloxyalkyl, hydrolyzed glycidyloxyalkyl, polysulfane, disulfane, thioether, polyether, vinyl, alkyl, alkenyl, alkynyl, aryl, alkylaryl, haloalkyl, ureido, sulfanealkyl, cyanate and/or isocyanate groups, the organofunctional groups being linear, branched and/or cyclic. The oligomeric silanes used preferably have the degrees of oligomerization specified above. The following groups are contemplated more particularly as organofunctional groups, especially as organofunctional group R on a structural element in the form of R— or R—Si or (R)₂Si:

Examples of preferred aminoalkyl groups as organofunctional group, more particularly as R in structural elements, may be selected from the following aminoalkyl groups (all indices correspond to whole numbers):

R¹_{h*}NH_{(2-h*)}[(CH₂)ₕ(NH)]ⱼ[(CH₂)ₗ(NH)]ₙ—(CH₂)ₖ— of the formula (I)

in which 0≦h≦6; h*=0, 1 or 2, j=0, 1 or 2; 0≦l≦6; n=0, 1 or 2; 0≦k≦6, and R¹ is a benzyl, aryl, vinyl or formyl radical and/or a linear, branched and/or cyclic alkyl radical having 1 to 8 C atoms, and/or

[NH₂(CH₂)ₘ]₂N(CH₂)ₚ— of the formula (II),

where 0≦m≦6 and 0≦p≦6. Preferably in formula (I) k=3, n=1 or 2, l=1, 2 or 3 and j=0, more preferably k=3, n=1 or 2, l=2, and j=0; m=2 and p=3 for a N,N-di(2-aminoethyl)-3-aminopropyl group as R in a structural element. Further examples of preferred aminoalkyl groups as organofunctional group R in structural elements are: aminopropyl-, H₂N(CH₂)₃—, diaminoethylene-3-propyl-, H₂N(CH₂)₂NH(CH₂)₃—; triaminodiethylene-3-propyl-, H₂N(CH₂)₂NH(CH₂)₂NH(CH₂)₃—, 2-aminoethyl-, 1-aminomethyl-, (2-aminoethylamino)ethyl-, 6-amino-n-hexyl-, and also, more particularly, 3-amino-n-propyl-, 1-aminomethyl-, N-butyl-3-aminopropyl-, N-butyl-1-aminomethyl-.

Preference may also be given to organofunctional groups, such as bis(monosilylalkyl)amine groups, more particularly as R in structural elements: —(CH₂)ᵢ—[NH(CH₂)_{f}]_{g}NH[(CH₂)_{f*}NH]_{g*}—(CH₂)ᵢ—Si of the formula (III), in which i, i*, f, f*, g or g* are identical or different, with i and/or i*=0 to 8, f and/or f*=1, 2 or 3, g and/or g*=0, 1 or 2, with i and/or i* corresponding more particularly to one of the numbers 1, 2, 3 or 4, preferably 3; particular preference is given to i, i*=3 and g, g*=0. Examples thereof are —(CH₂)₃NH(CH₂)₃—Si, —(CH₂)₃NH(CH₂)₃—Si, —(CH₂)₃NH(CH₂)₂NH(CH₂)₃—Si, —(CH₂)₃NH(CH₂)₂NH(CH₂)₂NH(CH₂)₃—Si, where bis(propyl)amine-Si may be particularly preferred. In this case the remaining free valences of the Si of the formula (III) may be satisfied by hydroxyl and/or siloxane groups, more particularly by —O—Si bridged siloxanes, and optionally by an alkyl radical having 1 to 24 C atoms. The oligomeric silanes containing bis(monosilylalkyl)amine groups are derived from the reaction of, for example, a bis(triethoxysilane)amine and/or bis(trimethoxysilane)amine and optionally other of the silanes having organofunctional groups as identified above, such as alkyl-group-functionalized silanes. Following hydrolysis and condensation, the solvent present is removed substantially completely.

Quaternary-aminoalkyl-functional groups, structural elements containing quaternary-amino-functional groups, or siloxanols, may for example, however, not be exclusively obtained from the reaction of at least one haloalkyl-functional radical of a silane of formula VIII and/or optionally the hydrolysis and/or condensation products thereof, i.e., including possible homo-, co-, block, and/or block cocondensates,

—(R⁶)_{n**}CH₂Hal (VIII),

in which the groups R⁶ are identical or different and are a linear, branched or cyclic alkylene group having 1 to 18 C atoms, i.e., a divalent alkyl group having 1 to 18 C atoms, where the alkylene group may be substituted or may contain olefinic C—C linkages, preferably —CH₂—, —(CH₂)₂—, —CH₂CH(CH₃)—, n** being 0 or 1, and Hal standing for chlorine or bromine, and reactive with a tertiary amine of the general formula IX in the presence of or with addition of a defined amount of water,

N(R⁷)₃ (IX),

in which the groups R⁷ are identical or different and R⁷ is a group (R*0)_{3-x-y}(R**)ₓSi[R⁶)_{n**}CH₂—]_{1+y}, where R⁶ and n** have the aforementioned definition, and R* are identical or different and R* is a hydrogen, a linear, branched or cyclic alkyl group having 1 to 8 C atoms, or an aryl, arylalkyl or acyl group, the groups R** are identical or different and R^{**} is a linear, branched or cyclic alkyl group having 1 to 8 C atoms, or an aryl, arylalkyl or acyl group, and x is 0, 1 or 2, y is 0, 1 or 2, and (x+y) is 0, 1 or 2, or R⁷ is a linear, branched or cyclic alkyl group having 1 to 30 C atoms, which in addition may be substituted, preferably by at least one group from the series —N(R⁸)₂, groups R⁸ being identical or different and R⁸ being a hydrogen, a linear, branched or cyclic alkyl group having from 1 to 8 C atoms, an aminoalkyl group or (R*0)_{3-x-y}(R**)ₓSi[(R⁶)_{n**}CH₂—]_{1+y}, or being —SR⁸, where groups R⁸ are identical or different and R⁸ is a hydrogen, a linear, branched or cyclic alkyl group having 1 to 8 C atoms or (R*0)_{3-x-y}(R**)ₓSi[(R⁶)_{n**}CH₂—]_{1+y} or optionally the hydrolysis and/or condensation products thereof, —OR or (R*0)₃₋ₓ(R**)ₓSi[(R⁶)_{n**}CH₂—] or optionally the hydrolysis and/or condensation products thereof, where the groups R*, R**, R⁶, x and n** independently have the definition already specified above, with optionally two groups R⁷ in turn being linked to one another and forming a ring with the nitrogen of the tertiary amine, and the hydrolysis alcohol formed being removed at least partly, preferably substantially completely. A particularly preferred quaternary oligomeric siloxanol can be obtained from the reaction of 3-chloropropyltriethoxysilane (CPTEO) with tetramethylethylenediamine (TMEDA), optionally in the presence of further silanes or condensation products thereof, and also subsequent removal of the hydrolysis alcohol, and usefully used in the process.

Examples of preferred alkyl groups as organofunctional group, more particularly as R in structural elements, may be linear, branched and/or cyclic alkyl groups, such as n-propyl, isopropyl, ethyl, methyl-, n-octyl, isobutyl, octyl, cyclohexyl and/or hexadecyl groups.

Examples of preferred epoxy and/or hydroxyalkyl groups as organofunctional group, more particularly as R in structural elements, may be glycidyloxyalkyl, 3-glycidyloxypropyl, epoxyalkyl and/or epoxycycloalkyl groups. More particularly glycidyloxyalkyl, epoxycyclohexyl may be preferred.

Examples of preferred haloalkyl groups as organofunctional group, more particularly as R in structural elements, may be derived from the formula (IV) R²—Y_{m*}—(CH₂)ₛ—, where R² is a mono-, oligo- or perfluorinated alkyl radical having 1 to 9 C atoms or a mono-, oligo- or perfluorinated aryl radical, and where, further, Y is a CH₂, O, aryl or S radical, and m*=0 or 1 and s=0 or 2. With particular preference the haloalkyl group may be a fluoroalkyl group, such as, preferably, a F₃C(CF₂)ᵣ(CH₂)ₛ group, where r is an integer from 0 to 9, s is 0 or 2, more preferably r is 5 and s is 2, CF₃(CF₂)₅(CH₂)₂ group or a CF₃(C₆H₄) or a C₆F₅ group. Preferred organofunctional groups R may be as follows: tridecafluoro-1,1,2,2-tetrahydrooctyl-1-, 3,3,3-trifluoropropyl-, 3,3,3,2,2-pentafluoropropyl-, 3,3,3-trifluoropropyloxyethyl-, 3,3,3-trifluoropropylmercaptoethyl-, tridecafluoro-1,1,2,2-tetrahydrooctyl-.

In accordance with one useful embodiment, the organofunctional group or R may be a bis-sulfanealkyl radical of the general formula V with —(CH₂)_{q}—X—(CH₂)_{q}—Si silyl group, where q=1, 2 or 3, X═Sₚ, where p on average is 2 or 2.18 or on average is 4 or 3.8 with a distribution of 2 to 12 sulfur atoms in the chain. Preferred groups R may be bis(propyl)disulfane-silyl groups prepared from (Si 266), bis(methyl)disulfane-silyl groups and/or bis(propyl)tetrasulfane-silyl groups prepared from (Si 69).

Exemplary aqueous, oligomeric siloxanols, derived from tris(alkoxysilylalkyl)amines, such as tris(triethoxysilane)amine and tris(trimethoxysilane)amine, have a tris-silylated amine structural element derived from the general formula VI: N[ZSi(R¹²)_{Ω}(OR²)_{3-Ω}]₃ (VI), where Z independently is a divalent alkylene radical, more particularly from the series —CH₂—, —(CH₂)₂—, —(CH₂)₃— or —[CH₂CH(CH₃)CH]—, R¹² is a linear, branched and/or cyclic alkyl radical having 1 to 24 C atoms, more particularly 1 to 16 C atoms, preferably 1 to 8 C atoms, more preferably 1 to 4 C atoms, or is an aryl radical, and independently Ω=0 or 1, R² is independently hydrogen or an alkyl group having 1 to 4 C atoms. The amine structural element is joined covalently via a siloxane linkage, an original OR² group, to the oligomeric siloxanol. Tris-N-aminoalkyl group functionalized oligomeric siloxanols may, like all oligomeric siloxanols that can be used in accordance with the invention, be prepared by homo- or co-condensation or else by block cocondensation with monomeric or else oligomeric silanes, which are substituted by one or more of the organofunctional groups that can be used in accordance with the invention, such as alkyl, haloalkyl and/or glycidyloxyalkyl groups, by hydrolysis and condensation, and removal of the alcohol. For suitability for the process of the invention, the oligomeric silanes are used in substantially solvent-free form.

Furthermore, the organofunctional group may be a terminally terminated polyether group of the formula VII, more particularly, the aqueous, oligomeric siloxanol may also be a linear, cyclic or branched polyether-functional siloxane or a mixture of polyether-functional siloxanes, obtained by hydrolysis and condensation, and more particularly substantially complete removal of the hydrolysis alcohol or of solvents present. With regard to the preparation of the stated silanes, reference is made in its entirety to the disclosure content of WO 2006/037380 A1. Terminally terminated polyether group of the formula VII

R³—O[R⁴—O]_{n*}[(—R⁵)_{m**}]— (VII),

in which R³ is a linear, branched or cyclic alkyl group having 1 to 8 C atoms, preferably methyl, or an alkylene group having 2 to 8 C atoms, preferably vinyl or allyl, or an aryl group having 6 to 12 C atoms, preferably benzyl or phenyl or styryl, R⁴ is identical or different and R⁴ is a divalent linear, branched or cyclic alkyl group having 1 to 8 C atoms, preferably —CH₂— (methyl as methylene), and correspondingly ethyl, n-propyl, isopropyl, n-butyl or tert-butyl, and R⁵ is a divalent linear, branched or cyclic alkyl group having 1 to 8 C atoms, preferably ethyl, n-propyl, isopropyl, n-butyl, and also isobutyl, n-octyl, isooctyl, n-hexadecyl, n-octadecyl, or fluoroalkyl, for example—but not exclusively—tridecafluoro-1,1,2,2-tetrahydroocytyl, or a mercaptoalkyl group, preferably 3-mercaptopropyl, or an alkylene group having 2 to 8 C atoms, preferably vinyl, or an alkynyl group having 2 to 8 C atoms, or an aryl group having 6 to 12 C atoms, preferably benzyl, phenyl or styryl, or an aminoalkyl group, as stated above, more particularly N-alkylaminoalkyl, such as N-(butyl)-3-aminopropyl or an epoxy group, as specified above, preferably 3-glycidyloxypropyl, and n* is 1 to 200, preferably 1 to 100, more preferably 2 to 40, more particularly 3 to 30, and also m** is 0 or 1. Particularly preferred polyether-functional, aqueous, oligomeric siloxanols which can be used in the process of the invention are disclosed by DE 10 2004 049, more particularly in paragraph [0037] and also in the examples; the content of this document and more particularly of this paragraph is hereby incorporated into this application.

In accordance with one preferred embodiment, silicon atoms of the oligomeric siloxanol, more particularly the structural elements, may possess two organofunctional groups or R; more particularly, the structural elements may have the following substitutions: aminopropyl/methyl; 2-aminoethyl/methyl, 2-aminoethyl/phenyl, 6-amino-n-hexyl/methyl, 3-amino-n-propyl/methyl, 1-aminomethyl/methyl, N-butyl-3-aminopropyl/methyl, N-butyl-1-aminomethyl/methyl, methyl/methyl, propyl/methyl, n-octyl/methyl, octadecyl/methyl hexyl/methyl, hexadecyl/methyl, 3,3,3-trifluoropropyl/methyl, 3,3,3-trifluoropropyl/cyclohexyl, 3,3,3-trifluoropropyl/phenyl, 3,3,3,2,2-pentafluoropropyl/methyl-3,3,3-trifluoropropyloxyethyl/methyl, triaminopropyl or aminopropyl or diaminopropyl/tridecafluorooctyl, triaminopropyl or aminopropyl or diaminopropyl/isobutyl, triaminopropyl or aminopropyl or diaminopropyl/isooctyl, triaminopropyl or aminopropyl or diaminopropyl/hexadecyl.

It is preferred in this context if 100% to 0.01% of the silicon atoms in the structural elements of the oligomeric siloxanol used are substituted by at least one organofunctional radical or R, more preferably 50% to 100%, very preferably 80% to 100%. A substitution by two organofunctional radicals may likewise be preferred. The remaining silicon atoms and/or the remaining bonding sites of the silicon atoms in the structural elements may be present as siloxane linkage or substantially as hydroxyl group in the oligomeric siloxanols.

The hydrolysis alcohol formed in the preparation of the oligomeric siloxanols or polysiloxanes, or the organic solvent used in the preparation, is removed substantially completely before the oligomeric siloxanols are used in the process of the invention or for preparing the composition obtainable in accordance with the invention.

Preferred aqueous, oligomeric silanes that are used in accordance with the invention, which also include polysiloxanes having corresponding structural elements, are known from patents EP 0675128, EP 0953591, EP 0716128, EP 0716127, EP 0832911, EP 1031593, WO 2007/085320, WO 2006/010388 A1, WO 2007/085339 and WO 2009/030538, WO 2006/037380, the disclosure content of which is referenced in full, and whose content is hereby adopted into this application. Reference is made more particularly to the examples given in the cited documents.

Particularly preferred oligomeric siloxanols substituted by only one organofunctional group have as the organofunctional group, more particularly group R, an epoxy group, such as, for example, glycidyloxyalkyl, 3-glycidyloxypropyl, a hydrolyzed glycidyloxyalkyl group or an amino group, such as, for example, aminoalkyl, more particularly N-alkylaminoalkyl, diaminoalkyl, triaminoalkyl, bis-N-aminoalkyl, bis-N-aminoalkylsilyl group, tris-N-aminoalkyl or else a tris-N-aminoalkylsilyl group.

Further particularly preferred oligomeric siloxanols have at least the following combinations of silicon atoms with the stated organofunctional groups or structural elements with the stated groups R, i.e., the oligomeric siloxanols are substituted by differently organofunctional groups, more particularly in accordance with alternatives a), b), c) and/or d):
a) by aminoalkyl groups, the aminoalkyl group including more particularly N-aminoalkyl, diaminoalkyl, triaminoalkyl, bis-(N-aminoalkyl), bis-N-aminoalkylsilyl, tris-N-aminoalkyl and/or tris-N-aminoalkylsilyl groups, and structural elements with alkyl groups. For example, an oligomeric silane in which R corresponds to diaminoalkyl and alkyl groups or to an amine group and to an alkyl group;
b) by fluoroalkyl groups and amino and/or aminoalkyl groups, where the aminoalkyl group includes more particularly N-aminoalkyl, diaminoalkyl, triaminoalkyl, bis-(N-aminoalkyl), bis-N-aminoalkylsilyl compound, tris-N-aminoalkyl groups and/or, tris-N-aminoalkylsilyl groups, optionally additionally by alkyl groups;
c) by haloalkyl groups and amino and/or aminoalkyl groups, the aminoalkyl group including more particularly N-aminoalkyl, diaminoalkyl, triaminoalkyl, bis-(N-aminoalkyl), bis-N-aminoalkylsilyl compound, tris-N-aminoalkyl groups and/or tris-N-aminoalkylsilyl groups;
d) by hydroxyalkyl, dihydroxyalkyl, epoxyalkyl and/or polyether groups, as designated above, and by amino and/or aminoalkyl group, the aminoalkyl group including more particularly N-aminoalkyl, diaminoalkyl, triaminoalkyl, bis-(N-aminoalkyl), bis-N-aminoalkylsilyl compound, tris-N-aminoalkyl groups and/or tris-N-aminoalkylsilyl groups, optionally additionally by a fluoroalkyl group; the stated halo- and/or fluoroalkyl groups may preferably be the groups already defined above, more particularly those fluoroalkyl functions as per —(CH₂)ₛ(CF₂)ᵣCF₃ with 0≦s≦16 and 0≦r≦16, preferably with s=2 and 0≦r≦13.

For all oligomeric siloxanols it is the case that the structural elements may be randomly distributed or else may be present as homocondensates, as block cocondensates with the organofunctional groups R in the oligomeric silanes. All oligomeric siloxanols used in accordance with the invention may be used individually or else as a mixture of oligomeric siloxanols, optionally in the presence of substantially completely hydrolyzed monomeric silanes.

For the preparation of a composition of the invention, in the process, preferably 1% to 60% by weight of fumed oxides, based on the overall composition to be prepared, are added to the oligomeric silane, more preferably from 2% to 40% by weight, and very preferably 3% to 25% by weight. Compositions of the invention may therefore have corresponding fumed oxide contents. It is preferred to disperse 0.1% to 60% by weight of fumed metal oxide in relation to the overall composition, more preferably 0.1% to 25% by weight, very preferably 0.1% to 20% by weight, better still 0.1% to 15% by weight.

The metal oxide is preferably added to the siloxanols with energy input in the process of the invention, more particularly by means of high stirring and/or mixing speeds and/or swirling for homogenizing and/or dispersing the siloxanols with the metal oxide. In alternatives, the energy input may also be accomplished by jetting the fumed metal oxides into the aqueous phase comprising oligomeric siloxanols. The fumed oxide may also be usefully added to the oligomeric siloxanol with subsequent energy input, more particularly for homogenization and/or dispersing.

The preferred preparation of a composition or dispersion of this kind is performed by incorporating the fumed silica, more particularly as a powder, into an aqueous solution of an already described oligomeric siloxanol or polysiloxane. The fumed silica or the metal oxide is added to the oligomeric siloxanol and stirred in. This is ideally done using a stirrer mechanism or dissolver. The stirring action brings the metal oxide preferably into the aqueous phase; more particularly, the metal oxide powders are in intimate contact with the aqueous phase, in order to allow reaction of the oligomeric siloxanols with the metal oxides. The powder introduced in this way can be dispersed preferably by high energy input. Suitable dispersion assemblies are, for example, rotor-stator systems such as, for example, an Ultraturrax or a Kinematica.

In the dispersion and reaction of the oligomeric silane with the fumed metal oxide, more particularly the fumed silica, the product experiences an increase in temperature. Normally the reaction is from between 10 and 100° C., preferably between 20 and 80° C., and more preferably between 25 and 60° C. In alternative process regimes, the metal oxide may be added to a heated oligomeric silane or the reaction mixture is heated subsequently. It is preferred, however, for the heat produced in the course of dispersing to be taken off by cooling of the reaction mixture.

The invention also provides a composition obtainable by the process described above, more particularly in accordance with any of claims 1 to 11; composition of the invention are obtainable without quaternary-aminoalkyl group(s) as functional group of the siloxanols, or are free from siloxanols with quaternary-aminoalkyl groups as organofunctional group, especially when obtainable by processes not in accordance with the invention, there being preferably at least one oligomeric siloxanol attached via at least one covalent bond to the fumed metal oxide. The composition, more particularly dispersion, obtained in this way may be a milky liquid and may have the viscosities described above.

The invention accordingly provides at least one composition comprising fumed metal oxides functionalized with oligomeric siloxanols, obtainable by intensively mixing
(i) at least one aqueous, substantially completely hydrolyzed, oligomeric, and organofunctional siloxanol or a mixture of oligomeric, organofunctional siloxanols, in particular consisting of these siloxanols, which is substantially free from organic solvents,
   in which each silicon atom of the siloxanol carries at least one functional group, and
   the functional group is identical or different and is selected
   a) to an extent of 50% to 100% from the organofunctional groups aminoalkyl, N-alkylaminoalkyl, diaminoalkyl, triaminoalkyl, bis-N-aminoalkyl, bis-N-aminoalkylsilyl, tris-N-aminoalkyl, tris-N-aminoalkylsilyl, mercaptoalkyl, methacryloyl, methacryloyloxyalkyl, hydroxyalkyl, epoxyalkyl, glycidyloxyalkyl, hydrolyzed glycidyloxyalkyl, polysulfane, disulfane, thioether, polyether, vinyl, alkyl, alkenyl, alkynyl, aryl, alkylaryl, haloalkyl, ureido, sulfanealkyl, cyanate and/or isocyanate groups, the organofunctional groups being linear, branched and/or cyclic, and
   b) to an extent of 0% to 50% the hydroxyl group,
   and the remaining free valences of the silicon atoms in the oligomeric siloxanols are satisfied by hydroxyl groups,
      with
(ii) at least one fumed metal oxide selected from the group of silica, metal oxide modified silica, and a metal oxide comprising at least silicon, aluminum, zirconium, titanium, iron, cerium, indium, samarium, tin, zinc, antimony, arsenic, tantalum, rhodium, ruthenium, cobalt, nickel, copper, silver, germanium and/or corresponding mixed oxides, or metal oxides modified therewith, the fumed metal oxide preferably being added as metal oxide power to the aqueous, oligomeric siloxanols and dispersed with the oligomeric siloxanols with high energy input by means of high stirring and/or mixing speeds.

In accordance with the process of the invention, the metal oxides, insoluble in aqueous phase, are attached to the oligomeric siloxanols, which are soluble in the aqueous phase, and thereby possibly improve the stability of the compositions comprising metal oxides. Prior to the application, the compositions of the invention and also the end products of the invention can when required be diluted advantageously to a concentration between 10% to 0.01% by weight, preferably to 5% to 01% by weight, with water or other solvents or else mixtures thereof.

The invention also provides a composition comprising at least one fumed metal oxide functionalized with oligomeric siloxanols and obtainable by a process of any of claims 1 to 11. The compositions of the invention may also be substantially water-free after a drying step. For example, if the process comprises the application of the composition to a substrate and/or a drying step, the composition may for example in the form of a coating on a substrate, preferably on a pretreated metallic substrate. This composition preferably comprises fumed metal oxides whose primary particles have an average particle size of between 2 to 100 nm, more particularly between 10 to 70 nm, preferably between 10 to 60 nm. Furthermore, a composition of the invention comprises dissolved fumed metal oxides, functionalized with oligomeric siloxanols, and water; the metal oxide is preferably completely dissolved.

In addition to the aforementioned features, the composition preferably has a volatile organic solvents content and/or hydrolysis alcohol content in the overall composition of below 5% by weight down to the detection limit, or to 0.0001% by weight, more particularly below 3% to 0.0001% by weight, preferably below 1% to 0.0001% by weight, with all of the constituents in the composition making 100% by weight in total.

Additionally or alternatively to the aforementioned features, the composition has a fumed metal oxide content of between 0.001% to 60% by weight, more particularly between 0.01% to 20% by weight, in relation to the metal oxide used in the overall composition.

The composition preferably consists more particularly of water and the reaction products of aqueous, substantially solvent-free, more particularly alcohol-free, and substantially completely hydrolyzed oligomeric, organofunctional siloxanols with at least one metal oxide, more particularly a fumed metal oxide, the oligomeric siloxanol being attached to the fumed metal oxide via at least one, or two or more, covalent bonds, and optionally one or more hydrolysis and/or condensation catalysts.

In accordance with one particularly preferred embodiment, the functionalized fumed metal oxide is dispersed in the composition in an aqueous, substantially solvent-free phase. This phase may where necessary be diluted further with water or with an aqueous phase, for the purpose, for example, of producing metal-treatment systems or coating materials.

At the same time the functionalized metal oxide, in accordance with statements above, is attached covalently to the oligomeric siloxanol, more particularly in the form of metal-oxygen-silicon bonds. The metal oxide typically forms a metal-oxygen bond with at least one silicon atom of the oligomeric silane used. This bond may be represented in idealized form as M-O—Si(—O—)ₐ(R)_{b}(OH)_{c}, where M symbolizes, generally, a metal atom in the metal oxide, which is joined covalently via an oxygen atom (—O—) to a silicon atom of an oligomeric siloxanol, where a, b and c independently of one another are 1, 2 or 3, and a+b+c are 3. Generally, the silicon atom may be joined covalently via (—O—)ₐ to other silicon atoms in the oligomeric siloxanol, or else to further metals M. R corresponds to the definition according to the invention.

The compositions of the invention of the functionalized fumed metal oxides can generally be diluted in any proportion with water. The compositions are judiciously diluted a certain time before the application, or in the context of use in a metal pretreatment system, with water or another solvent or solvent mixture. Customary processing concentrations, relative to the amount of fumed metal oxide functionalized with oligomeric siloxanols in a composition or a system, are preferably between 90% to 0.01% by weight; more particularly between 60% and 0.1% by weight, preferably between 40% and 0.5% by weight, more preferably between 30% and 1% by weight, in relation to the overall composition. The undiluted or diluted compositions can then be used in accordance with the invention as illustrated hereinafter.

Likewise provided by the invention is the use of the compositions of the invention, more particularly of any of claims 1 to 11 or 12 to 14, in or as metal pretreatment compositions or for producing metal pretreatment compositions or metal pretreatment systems. The compositions are used preferably as a base substance for the formulation of metal pretreatment compositions. For this purpose they may be admixed optionally with further adjvuants, such as, for example, water, organic solvents, solvent mixtures, additives for adjusting the pH, auxiliaries, wetting agents, such as BYK 348 or TEGO WET 742), anticorrosion pigments, pigments, anticorrosion additives, dyes, fillers, plastics, polymers, resins and/or additives for adjusting the viscosity.

The invention further provides for the use of a composition of the invention for modification, treatment and/or production of formulations, coatings, substrates, articles, metal pretreatment compositions, for production of corrosion protection for bright metal, as adhesion promoter for a coating on substrates, beneath a paint film for improving the corrosion protection, for the homogeneous introduction of fumed metal oxides into extraneous systems, for the promotion of adhesion of the paint film and/or for the setting of the viscosity of a coating material, sealant or adhesive, as for example of inks, paints, sealant pastes, or for producing metal pretreatment compositions. In this context it is particularly preferred if the compositions or metal pretreatment compositions comprising them, or coating materials, are used for modification, coating and/or treatment, or as adhesion promoters, for a coating on substrates, more particularly on chrome-plated, phosphatized, zinc-plated, tin-plated, etched and/or otherwise pretreated substrates. Preferred substrates for modification and/or treatment include metals or alloys comprising them, such as, more particularly, steel, steel alloys, aluminum, aluminum alloys, magnesium, magnesium alloys, bronze, copper, tin and/or zinc or an alloy of the stated metals. For this purpose the composition may preferably also be incorporated into paint formulations. In this case the substrate may have an untreated and/or treated surface. A treated surface may for example have been pretreated chemically, by electroplating, mechanically, by means of plasma and/or by means of other treatment methods.

Likewise provided by the invention is the use of the compositions of the invention, more particularly as or in metal pretreatment compositions, for producing bright metal corrosion protection, as adhesion promoters, more particularly on steel, steel alloys, aluminum, aluminum alloys, magnesium, magnesium alloys, bronze, copper, tin and/or zinc and/or substrates comprising them. Bright metals are interpreted, for example, to include metals which have not been tin-plated, zinc-plated, phosphatized or otherwise provided, chemically or by electroplating, with a protective layer. A chemical, mechanical and/or electroplating treatment for producing a bright metal which has been cleaned beforehand may contribute to the improved adhesion of the compositions.

The invention further provides for the use of the compositions, and of the metal pretreatment systems as well, beneath a coating film for the purpose of improving corrosion protection and/or for promoting adhesion of the coating film. For promoting adhesion, the functionalized metal oxide and/or the composition may be incorporated preferably into a paint formulation.

The invention further provides for the use of the compositions, and of the metal pretreatment systems, for adjusting, more particularly for increasing, the viscosity of a coating composition. The coating composition may also relate to a paint, a primer or, generally, a composition suitable for forming a thin layer following application to a substrate. The stated metal pretreatment compositions and systems, more particularly in the form of a dispersion, are applied preferably to metal substrates. The dispersion is applied preferably using a doctor blade, by dipping, flow-coating or spraying, or by the spin-coat method.

The metal substrates to be treated are composed preferably of steel, aluminum, magnesium, bronze, copper, tin, and zinc. The compositions and/or systems of the invention are preferably also applied to metal sheets that have already been pretreated, such as, for example, zinc-plated, tin-plated and phosphatized metal sheets and substrates, metal sheets and substrates treated with chromium(III) or chromium(VI), or metal sheets and substrates protected by other pretreatment methods.

The metal sheets thus treated may subsequently be dried preferably at a temperature between 10 and 200° C., preferably at a temperature between 20 and 150° C., and with particular preference at a temperature between 50 and 120° C.

The metal sheets thus pretreated may optionally be coated with a coating composition. Suitable coating compositions are, for example, solvent-based systems based on a polyurethane (both 1-component and 2-component), acrylate, from epoxy compounds, a polyester, alkyd or a solvent-free, UV-curing system based on an acrylate or on an epoxy compound. Furthermore, aqueous systems as well, based on melamine, or dispersions based on an acrylate or polyurethane, are preferred.

Furthermore, the compositions of the invention and/or functionalized metal oxides, more particularly as dispersions, may be introduced into a coating composition in order to increase the viscosity of the coating composition. This is necessary particularly in coating compositions which are applied by a spreading, spraying or squirting procedure.

Fumed silicas or organically modified fumed silica are often used in solventborne paints. In aqueous paints and inks, more particularly in aqueous paints and inks based, more particularly, substantially on a purely aqueous phase, this was hitherto not a possibility. The dispersions of the invention raise the thixotropy of the coating composition and hence improve its processing qualities, particularly in the context of application to the substrate.

In the compositions of the invention, more particularly in the dispersions, the silanes are anchored to the particles, more particularly via covalent bonds. In view of the anchoring of the oligomeric silanes to the fumed metal oxides, there is an increase in the stability of the compositions and/or of the functionalized metal oxides over a wide range of pH values. Before now, a normal dispersion based on fumed silica was stable for only a short time at low pH levels. With silane modification, the stability is much better, as will be shown below.

The invention also provides coatings, such as primers, tie coats, paint coat, which are obtainable by employing the composition of the invention and/or the functionalized metal oxides and/or using a composition or a functionalized metal oxide in a formulation, as for example in a paint. The invention also provides articles obtainable by treatment, modification and/or coating of a substrate with a composition of the invention, with a functionalized metal oxide and/or with a formulation comprising them.

The invention is described below with reference to a number of working examples, without the invention being confined to these examples.

### EXAMPLES

### Methods of Determination

The alcohol content after hydrolysis is determined by gas chromatography. This is done by hydrolyzing a sample of a defined amount with sulfuric acid (5 g sample, 25 ml H₂SO₄, w=20%). 75 ml of distilled water are added. This is followed by neutralization with aqueous sodium hydroxide solution, and a steam distillation is carried out. Internal standard 2-butanol. Determination of SiO₂ takes place after decomposition by means of sulfuric acid and Kjeldahl catalyst, by determining the weight of the SiO₂ separated out. The viscosity determination is made in general in accordance with DIN 53015 and also in accordance with DIN EM ISO 3219. The tapped density was determined in accordance with DIN EN ISO 707/11, August 1983. The determination of the solids content, i.e., of the nonvolatile fractions in aqueous and solvent-containing preparations, can be carried out in declination of DIN/EN ISO 3251 (Determination of the nonvolatile fraction of paints, coating materials and binders for paints and coating materials) as follows (QM-AA):

### Test Apparatus:

Thermometer (read accuracy 2 K), disposable aluminum trays
(d=about 65 mm, h=about 17 mm)
Analytical balance (accuracy 1 mg)
Drying cabinet to 250° C.
Desiccator

A sample is heated to a defined temperature (e.g., 125° C.), in order thus to remove the volatile fractions of the sample. The solids content (dry residue) of the sample after the heat treatment is captured.

About 1 g of sample (accuracy 1 mg) is weighed out on an analytical balance into a disposable tray. The product is distributed uniformly in the disposable tray by brief swirling. The tray is stored in a drying cabinet at about 125° C. for 1 hour. After the end of the drying procedure, the tray is cooled to room temperature in a desiccator for 20 minutes and reweighed on the analytical balance to an accuracy of 1 mg. At least 2 determinations should be carried out per experiment.

$$Solids content ( \% ) = \frac{final mass ( g ) \times 100}{initial mass ( g )}$$

Solids content—Percentage ratio of the sample mass before and after treatment; final mass: the sample mass after treatment; initial mass: the sample mass before the treatment.

### 1) Fumed Metal Oxides (A) and Oligomeric Siloxanols (B) Used

### a) Fumed Metal Oxides:

The fumed metal oxides of the invention that can be used generally exhibit a loss on drying (2 h at 105° C.) of less than or equal to 1.5% by weight in relation to the metal oxide used; preferred values are situated at less than or equal to 1.0% by weight. The loss on ignition of the thus-dried mixed oxide, which is determined subsequently to the loss on drying, is likewise situated in general at less than or equal to 1.5% by weight, preferably at less than or equal to 1°/0 by weight.

The fumed SiO₂ (py SiO₂−1) used was a hydrophilic fumed silica having a specific surface area (BET) in m²/g of about 200±25 m²/g. The amount of SiO₂ in the calcined substance is about ≧99.8% by weight. The average size (d₅₀) of the primary particles is around 12 nm. The tapped density is about 50 g/l. As a further fumed SiO₂ (py SiO₂-2), a hydrophilic fumed silica was used which had a specific surface area (BET) in m²/g of about 90±15 m²/g. The amount of SiO₂ in the calcined substrate is about ≧99.8% by weight. The average size of the primary particles (d₅₀) is around 20 nm. The tapped density is about 80 g/l. A frequent characteristic of the fumed silicas stated is that they are present in the form of particular aggregates of the primary particles, formed by partial fusion of the primary particles with formation of chains.

As a further fumed metal oxide, use was made as (py MO-1) of a hydrophilic fumed mixed oxide containing silicon dioxide with an aluminum oxide content of around 1% by weight, more particularly around 0.3 to 1.3% by weight, based on the overall composition. The amount of silicon dioxide in the calcined mixed oxide is around greater than or equal to 98.3% by weight. The specific surface area (BET) was found to be about 80±20 m²/g, with the primary particles having an average size of about 30 nm. The tapped density is about 60 g/l.

Furthermore, use was made as fumed mixed oxide, identified as py Mo-2, of a fumed hydrophilic mixed oxide containing silicon dioxide with an aluminum oxide content of about 1% by weight, more particularly about 0.3 to 1.3% by weight, based on the overall composition. The amount of silicon dioxide in the calcined mixed oxide is about greater than or equal to 98.3% by weight. The specific surface area (BET) was found to be about 170±30 m²/g, with the primary particles having an average size of about 15 nm. The tapped density is 50 g/l.

Also used was a fumed cerium dioxide (py CeO₂). The preferred specific surface area (BET) may be 50±15 m²/g.

A fumed titanium dioxide (TiO-1) having the following properties was likewise used. The amount of titanium dioxide, in relation to that calcined, is about greater than or equal to 99.5% by weight, based on the overall composition. The specific surface area (BET), for an average particle size found to be about 21 nm, is 50±15 m²/g. Around 130 g/l was ascertained as being the tapped density. As a result of its preparation, the fumed titanium dioxide may also contain extremely small amounts of the oxides of iron, aluminum and/or silicon.

### b) Examples of Preparation of the Aqueous, Oligomeric Siloxanols:

Used as reaction apparatus for all of the subsequent examples for the preparation of the aqueous, oligomeric siloxanols was a temperature-conditionable laboratory stirred-tank reactor with a capacity of 1 or 2 l, internal temperature measurement, liquid metering apparatus, distillation bridge with overhead temperature measurement, product condenser, distillate receiver vessel; laboratory suction filter (capacity 2 l). A vacuum pump served for establishing reduced pressure. Furthermore, any foaming problems that may occur can be prevented during distillation by adding a number of drops of a commercial defoamer, based on aqueous silicone resin emulsions, to the reaction solution. Any slight hazing resulting from addition of the defoamer can be removed by filtration on a suction filter with a glass fiber filter (pore size <1 μm).

The aqueous, oligomeric siloxanols prepared hereinbelow preferably have the following properties: The product is clear and is miscible with water in any proportion. The amount of alcohols and/or hydrolysable alkoxy groups is less than 3% by weight, preferably in general below 0.5% by weight. The flash point of the products is situated at levels >95° C. and also does not fall on further dilution with water, since no further hydrolysis takes place and hence no further alcohols are released.

### Preparation of Silox-1:

The aqueous, oligomeric siloxanol with hydrolyzed epoxy groups (Silox-1) is prepared by reaction of a 3-glycidyloxypropyltrimethoxysilane. The apparatus described above is charged with 708 g of 3-glycidyloxypropyltrimethoxysilane. 162 g of water and 3.5 g of formic acid (85% strength) are mixed and metered in over the course of 15 minutes. The temperature during this addition rises from 20 to 35° C. The batch is stirred at 60° C. for two hours. Thereafter, over the course of 8 hours, a methanol/water mixture is removed by distillation, and at the same time is replaced on a weight basis by water (pressure: 300-133 mbar; temperature: 42-52° C.). When the overhead temperature at 133 mbar is about 50° C. and the top product contains only water, the distillation is ended and the corresponding amount of water is added, to give a solution with w(3-glycidyloxypropyltrimethoxysilane)=40% in water.

### Preparation of Silox-2:

The aqueous, oligomeric siloxanol functionalized with diamino and alkyl groups (Silox-2) is prepared by reaction of 1 mol of aminoethylaminopropyltrimethoxysilane, 0.41 mol of methyltriethoxysilane, and 24.6 mol of deionized water in a 1 L three-neck flask with stirring motor, condenser and thermometer. At the start a temperature rise of about 30° C. is observed. Stirring was carried out for one hour. The mixture was admixed with 0.07 g of SAG 5693 (defoamer from the company OSi Specialties of Danbury, Conn.; surface-active silicone agent). The reaction apparatus was fitted with a Vigreux column (fractionating column) and with a distillation attachment with condenser. The reaction mixture was heated and the methanol/ethanol-water mixture was removed by distillation until the overhead temperature remained constantly at 100° C. The ethanol concentration is adjusted to below 1% by weight. The amount of distillate was replaced by the addition of water, and the batch was cooled.

### Preparation of Silox-3:

The aqueous, oligomeric siloxanol functionalized with diamino and alkyl groups (Silox-3) is prepared by reaction of 400 g of aminopropyltriethoxysilane and 600 g of deionized water in a 2 L three-neck flask with stirring motor, condenser and thermometer. At the start a temperature rise is observed. Stirring was carried out for one hour. The mixture was admixed with 0.07 g of SAG 5693 (defoamer from the company OSi Specialties of Danbury, Conn.; surface-active silicone agent). The reaction apparatus was fitted with a Vigreux column (fractionating column) and with a distillation attachment with condenser. The reaction mixture was heated and the ethanol-water mixture was removed by distillation until the overhead temperature remained constantly at 100° C. The ethanol concentration is adjusted to below 1% by weight. The amount of distillate was replaced by the addition of water, and the batch was cooled.

### Preparation of Silox-4:

An aqueous, oligomeric siloxanol (Silox-4) with aminopropyl and isobutyl groups in a molar ratio of 1:1 is prepared by mixing 221 g of aminopropyltriethoxysilane and 178 g of isobutyltrimethoxysilane in the apparatus described above, and adding 54 g of water. After half an hour, a further 64 g of water are added over the course of 15 minutes via the metering apparatus, with stirring. During this addition the temperature rises from 20° C. to about 60° C. Over the course of a further 15 minutes, 110 g of HCl (33% by weight in water) are metered in via the metering apparatus, with stirring. Over the course of about 4 hours, at a liquid-phase temperature of up to 52° C. and at a pressure of 130 mbar, an ethanol/methanol/water mixture is removed by distillation, until the overhead temperature is about 50° C. and the top product contains only water. During the distillation, via the metering means, water is supplied quantitatively to the product at the rate at which distillate is quantitatively removed.

### Preparation of Silox-5:

The preparation of an aqueous, oligomeric silane with hydrolyzed epoxy groups in the presence of an aqueous silica sol (Silox-5). 415.6 g of 3-glycidyloxypropyl-trimethoxysilane were introduced initially, and 20.6 g of acetic acid were added with stirring. Directly thereafter, 41.1 g of TYZOR® NPZ (zirconium tetra-n-propoxide) were metered in. After 5 minutes, the temperature had risen by about 2 to 5° C. Then, over the course of 1 minute, 417.0 g of Levasil® 100S45% (aqueous silica sol with 45% by weight solids content) were incorporated with stirring. A good stirring effect was ensured during this addition. Directly thereafter, 477.3 g of deionized water were added dropwise, likewise rapidly. Following attainment of the maximum temperature of about 42° C., the opaque dispersion was stirred further at 75 to 80° C. (reflux) for 2 hours. Following cooling to a liquid-phase temperature of around 50° C., the batch was admixed with 356.4 g of deionized water. The methanol was subsequently removed by distillation at a liquid-phase temperature of about 50 to 60° C. under an absolute pressure of about 270 mbar. At the end of the distillation, with the pressure unchanged, the liquid-phase temperature rose to 60 to 65° C. The overhead temperature likewise climbed to above 62° C. Only water was now distilled off, and thus the distillation was ended. After cooling to 50° C., the amount of deionized water removed by distillation, which was more than 59.4 g, was replaced. The methanol content is well below 3% by weight. The dispersion was stirred for a further period of at least 2 hours. It was dispensed at room temperature. The product obtained had a milky opaque appearance. The ratio of the solids mass of the silica sol to the mass of the 3-glycidyloxypropyltrimethoxysilane was 0.45. The yield, at 1498 g, was almost 100%.

The solids content, determined in accordance with DIN ISO 3251 (1 h, 125° C.), is about 36% by weight, and the SiO₂ content is around 16% by weight. The viscosity (20° C.), determined in accordance with DIN 53015, was around 8 mPa s. The pH was 4 to 5 and the density determined in accordance with DIN 1757, at 20° C., was 1.148 g/ml.

### 2) Stability on Storage of Dispersions with Fumed Metal Oxides

The examples below compare the stabilities of comparative examples with compositions of water and 20% fumed SiO₂ (py SiO₂-1) to 100% by weight, and of a composition of the invention, based on oligomeric siloxanols, into which 20% by weight of fumed SiO₂ (py SiO₂-1) has been incorporated, to 100% by weight.

a) Evaluation of the compositions 24 hours after preparation and storage at room temperature, Table 1.

TABLE 1

| | (py SiO₂-1) | Silox-1 with |
|---|---|---|
| | (20% by weight) | 20% by weight |
| pH | dispersion in water | (py SiO₂-1) |
| 4 | liquid | liquid |
| 6 | flocculation | liquid |
| 8 | liquid | liquid |
| 10 | liquid | liquid |

b) Evaluation of the compositions three days after preparation and storage at room temperature, Table 2.

TABLE 2

| | (py SiO₂-1) | Silox-1 with |
|---|---|---|
| | (20% by weight) | 20% by weight |
| pH | dispersion in water | (py SiO₂-1) |
| 4 | solid | liquid |
| 6 | solid | liquid |
| 8 | solid | liquid |
| 10 | liquid | liquid |

c) Evaluation of the compositions four weeks after preparation and storage at room temperature, Table 3.

TABLE 3

| | (py SiO₂-1) | Silox-1 with |
|---|---|---|
| | (20% by weight) | 20% by weight |
| pH value | dispersion in water | (py SiO₂-1) |
| 4 | solid | liquid |
| 6 | solid | liquid |
| 8 | solid | liquid |
| 10 | liquid | liquid |

### 3) Examples 1 to 27

For preparing the compositions and dispersions of the invention, the aqueous, oligomeric siloxane in each case was initially introduced and a fumed metal oxide in accordance with Table 4 below, was added. The batches were homogenized with a dissolver at 2000 rpm for 10 minutes. This was followed by dispersing with the Kinematica PT 3100 at 800 rpm for 15 minutes.

TABLE 4

| | | Oligo- | | |
|---|---|---|---|---|
| Exam- | Fumed metal oxide; | meric | | |
| ple | in [% by weight] | siloxanol | Stability of dispersion | pH |
| 1 | (py SiO₂-2); [4.8] | Silox-2 | slight sedimentation | 10.7 |
| 2 | (py SiO₂-2); [9.1] | Silox-2 | slight sedimentation | 10.7 |
| 3 | (py SiO₂-2); [16.7] | Silox-2 | stable | 10.7 |
| 4 | (py SiO₂-1); [4.8] | Silox-2 | stable | 10.7 |
| 5 | (py SiO₂-1); [16.7] | Silox-2 | stable | 10.7 |
| 6 | (py SiO₂-2); [16.7] | Silox-1 | stable | |
| 7 | (py SiO₂-1); [16.7] | Silox-1 | liquid after reagitation | |
| 8 | (py MO-1); [16.7] | Silox-1 | stable | 3.1 |
| 9 | (py MO-2); [16.7] | Silox-1 | stable | 3.0 |
| 10 | (py CeO₂); [4.8] | Silox-1 | stable | 3.66 |
| 11 | (py CeO₂); [16.7] | Silox-1 | stable | 3.76 |
| 12 | ZrO₂; [4.8] | Silox-1 | stable | 3.26 |
| 13 | ZrO₂; [16.7] | Silox-1 | stable | 3.45 |
| 14 | (py SiO₂-1); [4.8] | Silox-5 | stable | 4.53 |
| 15 | (py MO-1); [9.1] | Silox-5 | stable | 4.57 |
| 16 | (py MO-1); [16.7] | Silox-5 | stable | 4.53 |
| 17 | (py MO-2); [4.8] | Silox-5 | stable | 4.56 |
| 18 | ZrO₂; [4.8] | Silox-5 | slight sedimentation | 4.82 |
| 19 | ZrO₂, [16.7] | Silox-5 | slight sedimentation | 4.75 |
| 20 | (py SiO₂-2); [16.7] | Silox-3 | liquid after reagitation | 11.0 |
| 21 | (py SiO₂-1); [4.8] | Silox-3 | slight sedimentation | |
| 22 | (TiO-1); [16.7] | Silox-3 | slight sedimentation | |
| 23 | CeO₂; [4.8] | Silox-3 | slight sedimentation | |
| 24 | CeO₂; [16.7] | Silox-3 | slight sedimentation | |
| 25 | (py SiO₂-1); [9.1] | Silox-4 | stable | |
| 26 | (py SiO₂-1); [4.8] | Silox-4 | stable | |
| 27 | (py MO-2); [9.1] | Silox-4 | stable | |

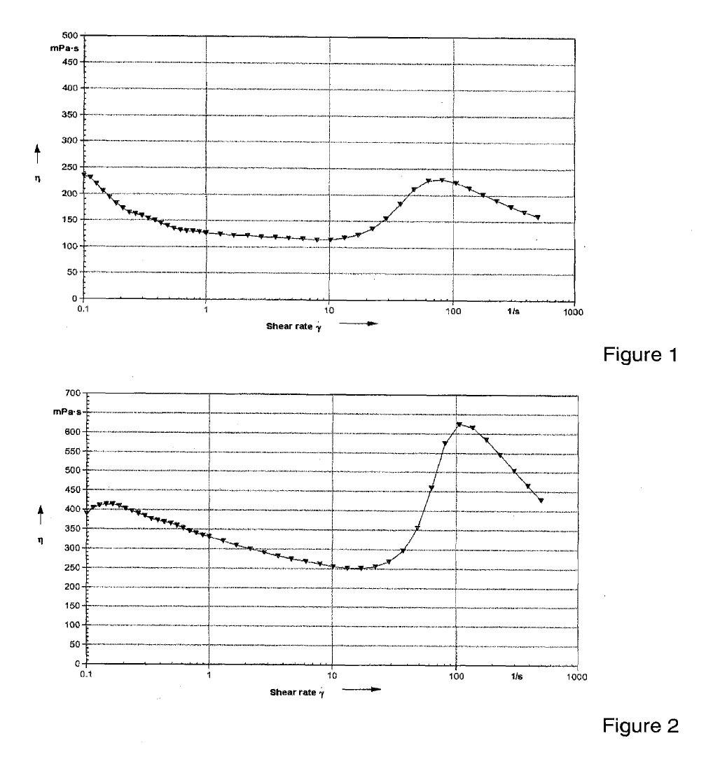

FIGS. 1 to 6 show the viscosity curves (viscosity (η) in m·Pas vs shear rate γ n in 1/sec) and particle size distribution of some of the examples:

FIG. 1: viscosity curve of example 3;

FIG. 2: viscosity curve of example 5;

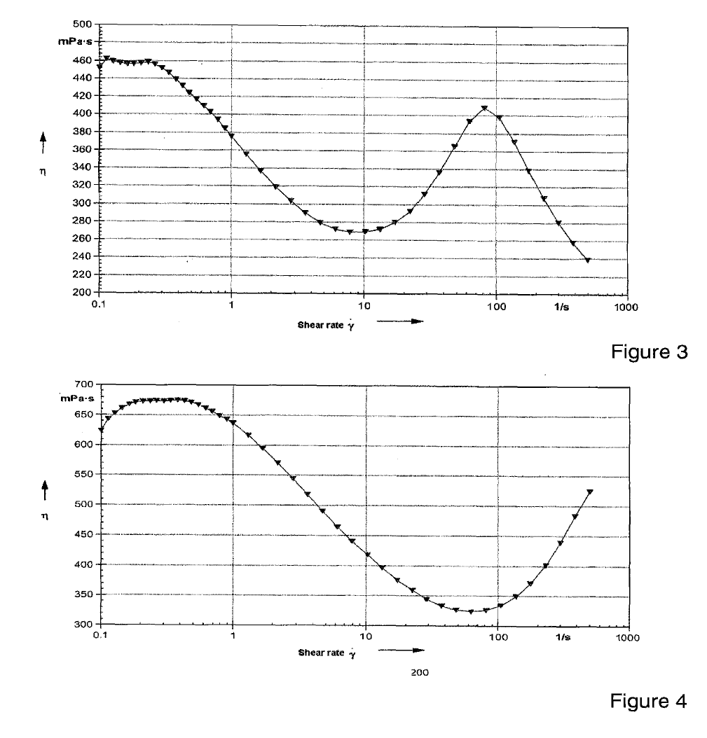

FIG. 3: viscosity curve of example 6;

FIG. 4: viscosity curve of example 7;

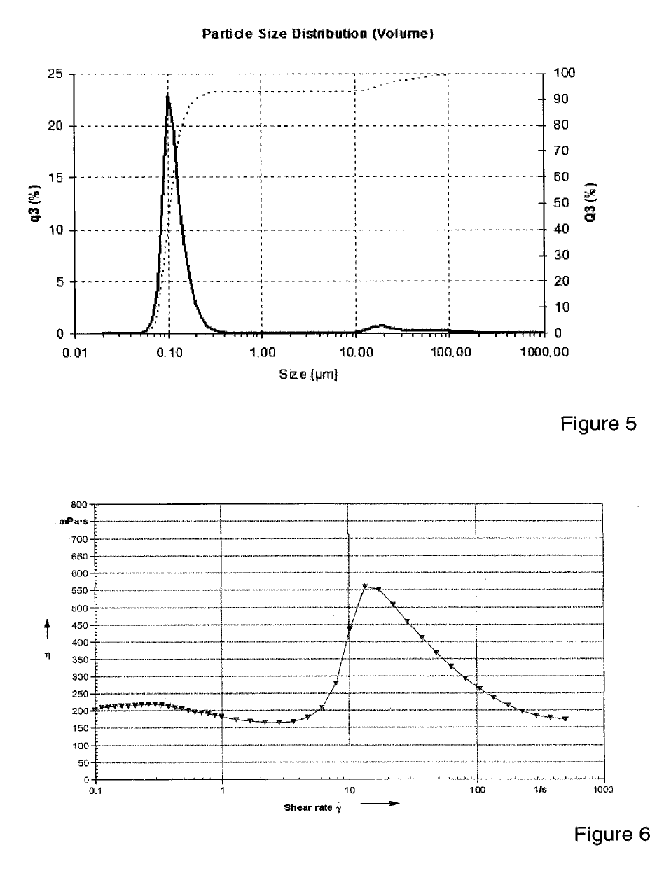

FIG. 5: particle size distribution in q3(%) vs size in (μm) of the fumed metal oxide of example 7;

FIG. 6: viscosity curve of example 20;

### 4) Examples 28-42

Examples 28 to 42 describe preparation examples for formulations suitable for metal pretreatment. For this purpose the compositions from the examples in section 3) were mixed with water, as described below in Table 5, and applied to metal substrates.

TABLE 5

| | | Amount used | | |
|---|---|---|---|---|
| | | of composition | Water | |
| | Dispersion of | from example | [% by | |
| Example | example | [% by weight] | weight] | Substrate |
| 28 | 7 | 30 | 70 | V + P |
| 29 | 26 | 30 | 70 | V + P |
| 30 | 4 | 30 | 70 | V + P |
| 31 | 4 | 30 | 70 | V |
| 32 | 4 | 7.5 | 92.5 | V + P |
| 33 | 4 | 1.5 | 98.5 | V + P |
| 34 | 4 | 7.5 | 98.5 | V |
| 35 | 4 | 1.5 | 92.5 | V |
| 36 | 5 | 30 | 70 | V + P |
| 37 | 5 | 30 | 70 | V |
| 38 | 21 | 30 | 70 | V + P |
| 39 | 21 | 30 | 70 | V |
| 40 | 24 | 30 | 70 | V + P |
| 41 | 24 | 30 | 70 | V |
| 42 | 10 | 30 | 70 | V + P |

### Key to Tables 5 and 6:

Steel sheets, V+P: hot dip galvanized, zinc-manganese phosphatized. Metal sheets from Chemetall (Gardobond 26/1 S/GN D60/OE)
V: hot dip galvanized, metal sheets from Chemetall (Gardobond OE)

TABLE 6
Comparative examples 1 to 10

| | Aqueous, | Amount of aqueous, | Water | |
|---|---|---|---|---|
| Comparative | oligomeric | oligomeric siloxanol | [% by | |
| example | siloxanol | used [% by weight] | weight] | Substrate |
| 1 | Silox-4 | 30 | 70 | V + P |
| 2 | Silox-1 | 30 | 70 | V + P |
| 3 | Silox-3 | 30 | 70 | V + P |
| 4 | Silox-3 | 30 | 70 | V |
| 5 | Silox-2 | 30 | 70 | V + P |
| 6 | Silox-2 | 30 | 70 | V |
| 7 | Silox-2 | 7.5 | 92.5 | V + P |
| 8 | Silox-2 | 1.5 | 98.5 | V + P |
| 9 | Silox-2 | 7.5 | 98.5 | V |
| 10 | Silox-2 | 1.5 | 92.5 | V |

TABLE 7
Salt spray test on untreated and treated metal sheets (cf. Table 5, 6)

| Experiment | 48 h SS | 72 h SS | 216 h SS | 288 h SS | 576 h SS |
|---|---|---|---|---|---|
| No treatment | 0 | 0 | − | −− | −− |
| Comparative | + | + | 0 | 0 | −− |
| example 4 | | | | | |
| Example 39 | + | + | 0 | 0 | − |
| Example 41 | + | + | 0 | 0 | 0 |
| Comparative | + | 0 | 0 | − | −− |
| example 6 | | | | | |
| Example 4 | + | 0 | 0 | 0 | − |
| Example 5 | ++ | ++ | + | 0 | 0 |

### Key to Tables 7 and 8:

++: Very good surface, white rust only to small extents.
+: Surface partly covered with white rust.
0: White rust on the entire surface, no red rust yet.
-: Small amount of red rust.

—: Already significant amounts of red rust.

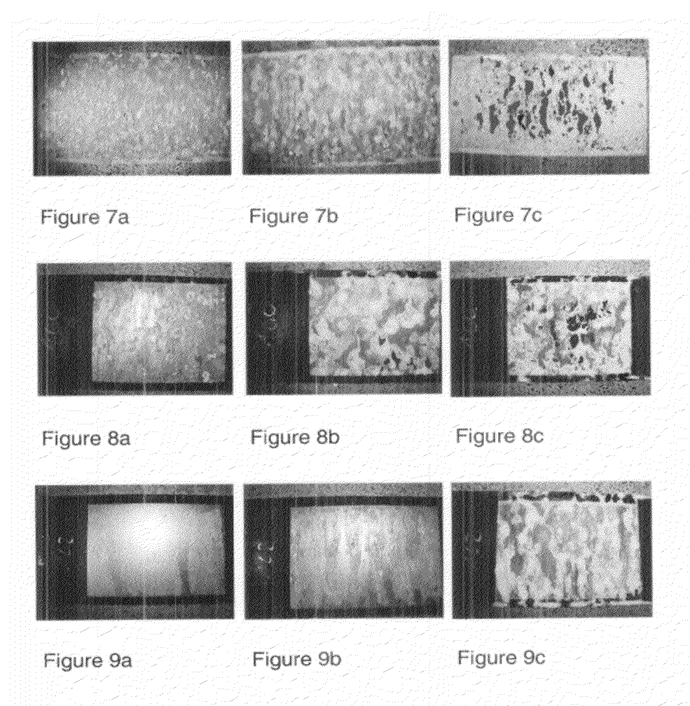

The pictures in FIGS. 7 a/b/c to 9 a/b/c show in photo form the changes to the metal sheet surfaces after 144, 216, and 576 hours of salt spray testing.

FIG. 7 a/b/c: Metal sheet without treatment; FIG. 7a: after 144 hours in salt spray test; (in accordance with DIN-EN-ISO 9227-2006) FIG. 7b: after 216 hours in salt spray test; FIG. 7c: after 576 hours in salt spray test;

FIG. 8a/b/c: Comparative example 6; FIG. 8a: after 144 hours in salt spray test;

FIG. 8b: after 216 hours in salt spray test; FIG. 8c: after 576 hours in salt spray test;

FIG. 9a/b/c: Example 5; FIG. 9a: after 144 hours in salt spray test; FIG. 9b: after 216 hours in salt spray test; FIG. 9c: after 576 hours in salt spray test;

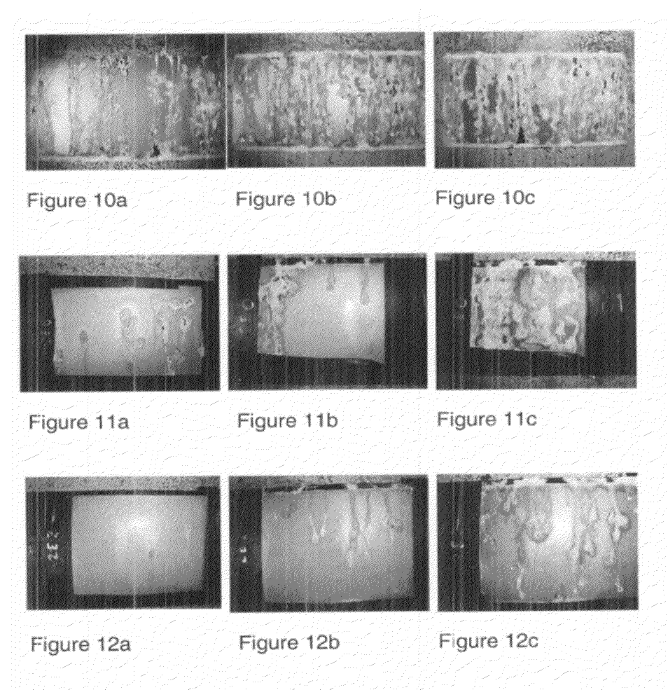

The pictures in FIGS. 10 a/b/c to 12 a/b/c show in photo form the changes to the metal sheet surfaces after 144, 216, and 480 hours of salt spray testing.

FIG. 10 a/b/c: Metal sheet without treatment; FIG. 10a: after 114 hours in salt spray test; FIG. 10b: after 216 hours in salt spray test; FIG. 10c: after 576 hours in salt spray test;

FIG. 11 a/b/c: Comparative example 2; FIG. 11 a: after 144 hours in salt spray test; FIG. 11 b: after 216 hours in salt spray test; FIG. 11 c: after 480 hours in salt spray test;

FIG. 12a/b/c: Example 28; FIG. 12a: after 144 hours in salt spray test;

FIG. 12b: after 216 hours in salt spray test; FIG. 12c: after 480 hours in salt spray test.

TABLE 8
Salt spray test on untreated and treated metal sheets

| Experiment | 144 h SS | 216 h SS | 384 h SS |
|---|---|---|---|
| Without treatment | 0 | 0 | 0 |
| Comparative example 3 | ++ | + | 0 |
| Comparative example 5 | + | 0 | 0 |
| Comparative example 1 | ++ | + | 0 |
| Comparative example 2 | + | + | 0 |
| Example 38 | + | 0 | 0 |
| Example 40 | No change | ++ | 0 |
| Example 36 | ++ | + | 0 |
| Example 29 | No change | ++ | 0 |
| Example 28 | ++ | + | + |
| Example 42 | + | 0 | 0 |

For key, see Table 7.

### Example 43

### Use of a Dispersion for Changing the Viscosity of a Paint Formulation

TABLE 9

| | Dispersion of |
|---|---|
| | (py SiO₂-1) and |
| Raw materials [g] | Silox-1 |
| Silox-1 | 200 |
| (py SiO₂-1) | 40 |
| Total | 240 |

The formula ingredients were weighed out in the sequence of the formula, with stirring. Thereafter the batches were homogenized for 10 minutes with a dissolver at 2000 rpm. This was followed by dispersing with the Kinematica PT 3100 at 8000 rpm for 15 minutes.

TABLE 10

| | Dispersion: | Alkaline | |
|---|---|---|---|
| | (py SiO₂-1) and | dispersion | |
| | Silox-1 | (py SiO₂—KOH) | Silox-1 |
| pH value | 2.8 | 9.6 | 3 |
| (py SiO₂-1) [%] by | 16.6 | 20 | — |
| weight | | | |
| SiO₂ - [%] by weight | 25 | 20 | 10 |
| Solid - [%] by weight | 25 | 20 | — |

The alkaline dispersion (py SiO₂-KOH) used was a KOH-stabilized dispersion of hydrophilic, fumed silica. The viscosity, determined at a shear rate of 100 s⁻¹ in accordance with DIN EN ISO 3219, was less than or equal to 300 mPa s. Table 11 shows paints produced using the composition set out in Table 10.

TABLE 11

| AL | 0 | 1 | 4 | 6 |
|---|---|---|---|---|
| Bayhydrol A 145 | 62.54 | 62.54 | 62.54 | 62.54 |
| Surfynol 104 BC | 1 | 1 | 1 | 1 |
| Dispersion (py SiO₂-1) + Silox-1 | | 8 | | |
| Alkaline dispersion | | | 10 | |
| (py SiO₂—KOH) | | | | |
| Silox-1 | | | | 8 |
| Baysilone 3468:3466, 3:7, | 0.99 | 0.99 | 0.99 | 0.99 |
| 10% in BG | | | | |
| Demin. H₂O | 13.9 | 5.9 | 3.9 | 5.9 |
| Dipropylene glycol | 2 | 2 | 2 | 2 |
| Bayhydur VP LS 2319 | 19.57 | 19.57 | 19.57 | 19.57 |
| Total | 100 | 100 | 100 | 100 |

For application by spraying, the paint is adjusted in viscosity by addition of water, ISO 2431. The following amounts of water were added in the individual experiments:

TABLE 12

| | | 1 | 4 | |
|---|---|---|---|---|
| | 0 | Silox-1 + | Alkaline | |
| | Blank | (py SiO₂-1) | dispersion | 6 |
| AL | sample | sample 1 | (py SiO₂—KOH) | Silox-1 |
| Dilution H₂O in % | 4.5 | 11 | 8.5 | 6 |
| to 26 s DIN 4 mm: | | | | |

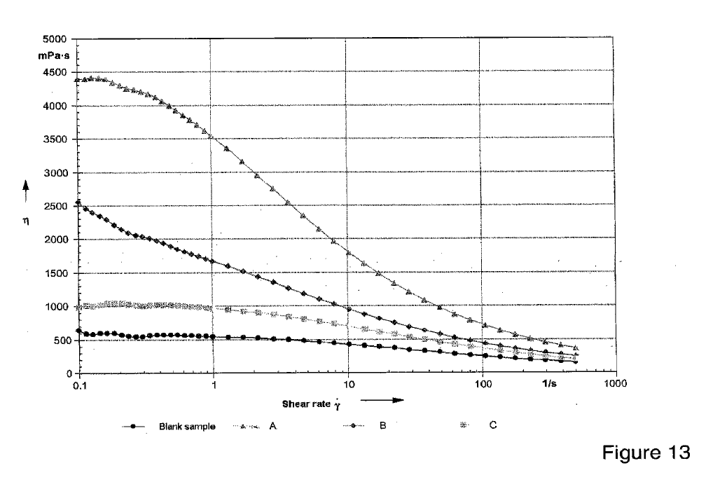

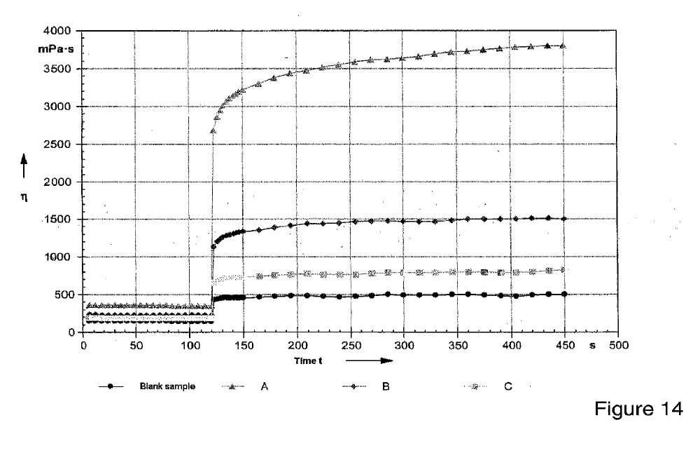

FIGS. 13 and 14 show the thixotropic behavior of the dispersion. Example (A) shows significantly more pronounced thixotropy than B and C.

Blank sample is the paint without rheological additives: A=example; B=(py SiO₂-1) dispersion; C=Silox-1

TABLE 13

| | | | 4 | |
|---|---|---|---|---|
| | 0 | 1 | Alkaline | |
| | Blank | Silox-1 + | dispersion | 6 |
| AL | sample | (py SiO₂-1) | (py SiO₂—KOH) | Silox-1 |
| Haze: | 21 | 10.8 | 178 | 11.3 |
| Gloss at 20°: | 82.0 | 82.6 | 69.7 | 82.5 |
| Black number My: | 282 | 273 | 270 | 279 |
| Long wave: | 0.5 | 0.3 | 12 | 0.6 |
| Short wave: | 1.9 | 0.9 | 25 | 2 |
| Film thickness: | 52 μm | 60 μm | 52 μm | 56 μm |

TABLE 14
\dot{γ} (shear rate)

| | |
|---|---|
| Dispersing | Mix letdown mixture with paddle stirrer at 2000 rpm |
| | for 10 min, formula ingredients are added with |
| | stirring, homogenized addition of curing agent |
| | with paddle stirrer at 2000 rpm for 10 min. |
| Viscosity | Paints: flow curves and onset tests after addition of the |
| measurement of | curing agent |
| the dispersions | Flow curve: Preliminary shearing \dot{γ} = 50 s−1 (30 s) |
| and paints | resting (600 s) |
| | Measurement \dot{γ} = 0.1 s−1 to 500 s−1 (150 s) |
| | Onset test: 120 s at \dot{γ} = 500 s−1 |
| | 300 s at \dot{γ} = 0.5 s−1 |
| Application | Spray application to black-painted metal sheets (DT36) |
| | with a manual gun 1.4 mm. 1 cross-pass at 3 bar |
| | pressure |
| Curing | 30 min evaporation at RT (22° C., 55% relative |
| | humidity) and 30 min at 60° C. in a drying oven, |
| | testing of the paints after one week of conditioning |
| | at RT. |
| 20° reflectometer | Appraisal is made on paint films applied to black metal |
| value/haze | sheets, using a reflectometer from Byk Gardner, e.g., |
| | DIN 67530 |
| Black number My | Determination is made on paint films applied to metal |
| (assessment of | sheets sprayed black, using a densitometer D19C from |
| transparency) | Gretag Macbeth. The black number My is the figure |
| | measured, multiplied by one hundred. |
| Wave scan | The profile is assessed by means of a wave-scan plus |
| (profile) | instrument from Byk-Gardner. |

1. A process for preparing a composition comprising a fumed metal oxide functionalized with at least one oligomeric siloxanol, the process comprising intensively mixing:
(i) at least one aqueous, substantially completely hydrolyzed, oligomeric, and organofunctional siloxanol or a mixture of oligomeric, organofunctional siloxanols which is substantially free from organic solvents,
wherein each silicon atom of the siloxanol, or mixture of silanols, comprises at least one functional group, said functional group is independently
a) to an extent of 50% to 100%, at least one organofunctional group selected from the group consisting of aminoalkyl, N-alkylaminoalkyl, diaminoalkyl, triaminoalkyl, bis-N-aminoalkyl, bis-N-aminoalkylsilyl, tris-N-aminoalkyl, tris-N-aminoalkylsilyl, quaternary-aminoalkyl, mercaptoalkyl, methacryloyl, methacryloyloxyalkyl, hydroxyalkyl, epoxyalkyl, glycidyloxyalkyl, hydrolyzed glycidyloxyalkyl, polysulfane, disulfane, thioether, polyether, vinyl, alkyl, alkenyl, alkynyl, aryl, alkylaryl, haloalkyl, ureido, sulfanealkyl, cyanate group isocyanate group, such that the at least one organofunctional group is linear, branched and/or cyclic, and
b) to an extent of 0% to 50%, a hydroxyl group, such that remaining free valences of the silicon atoms in the oligomeric siloxanols are filled by hydroxyl groups;
with
(ii) at least one fumed metal oxide selected from the group consisting of silica, metal oxide modified silica, and a metal oxide comprising at least silicon, aluminum, zirconium, titanium, iron, cerium, indium, samarium, tin, zinc, antimony, arsenic, tantalum, rhodium, ruthenium, cobalt, nickel, copper, silver, germanium, a mixed oxide thereof, and a metal oxide modified therewith.

2. The process of claim 1, wherein the fumed metal oxide is added as metal oxide powder to the aqueous, oligomeric siloxanol or siloxanols and is dispersed with the at least one oligomeric siloxanol with a high input of energy by stirring, mixing, or both, a high speed.

3. The process of claim 1, wherein the fumed metal oxide is selected from the group consisting of SiO₂, Al₂O₃, TiO₂, HfO₂, Y₂O₃, ZrO₂, Fe₂O₃, Nb₂O₅, V₂O₅, WO₃, SnO₂, GeO₂, B₂O₃, In₂O₃, ZnO, CaO, a manganese oxide, a lead oxide, MgO, BaO, SrO, mixed oxides thereof, and metal oxides modified therewith.

4. The process of claim 1, wherein 0.001% to 60% by weight of the fumed metal oxide is dispersed, relative to the overall composition.

5. The process of claim 1, wherein the at least one oligomeric siloxanol has a degree of oligomerization of at least 4.

6. The process of claim 1, wherein primary particles of the fumed metal oxide have an average particle size (d₅₀) of between 2 to 100 nm.

7. The process of claim 1, wherein the mixing occurs at stirring speeds of more than 1000 revolutions per minute.

8. The process of claim 1, wherein the at least one organofunctional group independently of one another comprises at least one of the following:
a) an aminoalkyl group of the formulae (I), (II), or both (I) and (II):
R¹_{h*}NH_{(2-h*)}[(CH₂)ₕ(NH)]ⱼ][(CH₂)ₗ(NH)]ₙ—(CH₂)ₖ— (I),
wherein:
0≦h≦6;
h*=0, 1 or 2;
j=0, 1 or 2;
0≦1≦6;
n=0, 1 or 2;
0≦k≦6; and
R¹ is independently a benzyl radical, an aryl radical, a vinyl radical, a formyl radical, or a linear, branched and/or cyclic alkyl radical having 1 to 8 C atoms,
[NH₂(CH₂)ₘ]₂N(CH₂)ₚ— (II),
wherein:
0≦m≦6; and
0≦p≦6;
b) at least one alkyl group selected from the group consisting of n-propyl, isopropyl, ethyl, methyl, n-octyl, isobutyl, octyl, cyclohexyl, and hexadecyl groups;
c) an epoxy- and/or hydroxyalkyl group selected from the group consisting of a glycidyloxyalkyl group, an epoxyalkyl group, and an epoxycycloalkyl group; and
d) a haloalkyl group of the formula (IV):
R²—Y_{m*}—(CH₂)ₛ— (IV),
wherein:
R² is a mono-, oligo- or perfluorinated alkyl radical having 1 to 9 C atoms or a mono-, oligo- or perfluorinated aryl radical,
Y is a CH₂, O, aryl or S radical
m*=0 or 1; and
s=0 or 2.

9. The process of claim 1, wherein the process comprises intensively mixing at least one mixture of oligomeric, organofunctional siloxanols comprising at least two structural elements selected from the group consisting of —O—Si(OH)(R)—, —O—Si(OH)₂(R), (—O—)₂(HO)SiR, (—O—)₃SiR, (—O—)₃Si(OH), (—O—)₂Si(OH)₂, (—O—)₄Si, —O—Si(OH)₂—, —O—Si(R)₂—, —O—Si(OH)(R)₂, and (—O—)₂Si(R)₂, such that R is independently is the at least one organofunctional group.

10. The process of claim 1, wherein the composition has a viscosity of between 5 to 8000 mPa·s.

11. The process of claim 1, wherein the process is carried out substantially without presence of organic solvents or organic polymers.

12. A composition, comprising a fumed metal oxide functionalized with at least one oligomeric siloxanol obtained by the process of claim 1.

13. The composition of claim 12, wherein primary particles of the fumed metal oxide have an average particle size of between 2 to 100 nm.

14. The composition of claim 12, comprising a fumed metal oxide content of between 0.001% to 60% by weight, based on an overall metal oxide content in the composition.

15. A process, comprising adding or applying the composition of claim 12 to an article or separate composition, wherein the process is suitable for at least one selected from the group consisting of:
modification, treatment and/or production of formulations, coatings, substrates, articles, and metal pretreatment compositions;
corrosion protection for bright metal;
production of an adhesion promoter for a coating on substrates;
corrosion protection by applying beneath a paint film;
homogeneous introduction of fumed metal oxides into extraneous systems;
promotion of adhesion of a paint film; and
setting the viscosity of a coating material, sealant or adhesive.

16. The process of claim 15, which is suitable for modification, coating and/or treatment of a chrome-plated, phosphatized, zinc-plated, tin-plated, etched and/or otherwise pretreated substrate.

17. The process of claim 16, wherein the pretreated substrate comprises a metal or alloy.

18. The process of claim 1, wherein the at least one oligomeric siloxanol has a degree of oligomerization of between 4 to 100 000.

19. The process of claim 1, wherein the composition has a viscosity of between 15 to 1500 mPa·s.

20. The composition of claim 12, wherein primary particles of the fumed metal oxide have an average particle size of between 10 to 70 nm.
